(19) United States
(12) Patent Application Publication
(10) Pub. No.: US 2025/0353002 A1
(43) Pub. Date: Nov. 20, 2025

(54) Microfluidic Device For Profiling Biochemical Samples

(71) Applicant: Wisconsin Alumni Research Foundation, Madison, WI (US)

(72) Inventors: Jose Ayuso, Verona, WI (US); Rithvik Turaga, Madison, WI (US); Catherine Reed McBain, Madison, WI (US); Seth Zima, Madison, WI (US)

(21) Appl. No.: 18/664,936

(22) Filed: May 15, 2024

(51) Int. Cl. B01L 3/00

(52) U.S. Cl. CPC B01L 3/5025; B01L 2200/0642; B01L 2300/048; B01L 2300/0816; B01L 2300/0864; B01L 2400/0406

(57) ABSTRACT

A microfluidic device for profiling biochemical samples is provided. The microfluidic device includes a cartridge defining a channel network. The channel network includes a channel having first and second opposite ends. A first loading port is in communication with the channel. A well is in communication with the channel through a second loading port and is located between the first loading port and the second end of the channel. The second well is adapted for receiving a second fluid therein. An air outlet is in communication with channel at a location adjacent to the second end of the channel. The second loading port has a dimension to pin the second fluid in the second well. The first fluid received in the first well flows into the channel toward the air outlet. At least a portion of the first fluid flowing through the channel flows into the second well through the second loading port.

### FIELD OF THE INVENTION

This invention relates generally to biochemical profiling, and in particular, to a microfluidic device for profiling biochemical samples, such as biochemical analytes and/or cell types, which allows a user to evaluate multiple functional and molecular readouts in an efficient, user-friendly, high-throughput manner.

### BACKGROUND AND SUMMARY OF THE INVENTION

Profiling is a process whereby biochemical analytes and/or cell populations in a biological sample are identified and quantified according to their physical properties and functional characteristics. Current methods for profiling are time consuming, laborious, and/or require highly specialized equipment to perform. For example, an enzyme-linked immunosorbent assay (ELISA) may be used to measure antibodies, antigens, proteins and glycoproteins in biological samples. However, ELISAs require a great deal of time, expensive antibodies, and many pipetting steps.

Alternatively, profiling may be conducted using flow cytometry. In flow cytometry, a sample containing cells or particles is suspended in a fluid and injected into the flow cytometer instrument, which rapidly analyzes single cells or particles as they flow past single or multiple lasers. While functional for its intended purpose, the use of flow cytometry to conduct profiling requires large volumes of blood, typically on the order of milliliters. As such, a trained phlebotomist is often needed to draw the blood for use, thereby increasing the cost of the procedure. Further, flow cytometry also requires high amounts of sample and reagents, which can be difficult and costly to obtain, as well as, training for processing the raw data generated.

In a still further alternative, microfluidic devices and/or platforms have been developed to perform cell-based assays. These microfluidic devices/platforms are usually made from polydimethylsiloxane (PDMS), which requires specialized equipment to fabricate, are usually difficult to load, and are typically highly specific in their usage. Further, these microfluidic devices/platforms are usually distributed already assembled and are challenging to customize without expertise in microfabrication and soft lithography techniques. In addition, these microfluidic devices and/or platforms often require the use of specialized pumping equipment, such as a syringe pump, to drive fluid flow throughout the device. This, in turn, increases the cost and complexity of the microfluidic devices and/or platforms.

In view of the foregoing, it is primary object and feature of the present invention to provide a microfluidic device for profiling biochemical samples, such as biochemical analytes and/or cell types, which allows a user to evaluate multiple functional readouts in an efficient, user-friendly, high-throughput manner.

It is further object and feature of the present invention to provide a microfluidic device for profiling biochemical samples, such as biochemical analytes and/or cell types, which utilizes smaller volumes of blood than prior devices/methods.

It is a further object and feature of the present invention to provide a microfluidic device for profiling biochemical samples, such as biochemical analytes and/or cell types, which does not require specialized pumping equipment and is highly compatible with many common laboratory instruments.

It is a still further object and feature of the present invention to provide a microfluidic device for profiling biochemical samples, such as biochemical analytes and/or cell types, which is simple to use and inexpensive to manufacture.

In accordance with the present invention, a microfluidic device is provided for profiling biochemical samples. The microfluidic device includes a cartridge defining a channel network. The channel network includes a channel having first and second opposite ends. A first well is adjacent the first end of the channel. The first well is adapted for receiving a first fluid therein. A first loading port extends between the first well and the channel. The first loading port has a sufficient dimension to allow the first fluid to flow into the channel. A second well is disposed between the first and second ends of the channel. The second well adapted for receiving a second fluid therein. A second loading port extends between the second well and the channel. The second loading port has a dimension to pin the second fluid in the second well. An air outlet is adjacent to the second end of the channel. The air outlet allows an interior of the channel to communicate with an environment external of the cartridge. Capillary action causes the first fluid received in the first well to flow into the channel through the first loading port and toward the air outlet. At least a portion of the first fluid flowing through the channel flows into the second well through the second loading port.

The channel may be a first channel and the air outlet may be a first air outlet. The channel network may also include a second channel having first and second opposite ends. A third well is adjacent the first end of the second channel. The third well is adapted for receiving a third fluid therein. A third port extends between the third well and the second channel. The third loading port has a sufficient dimension to allow the third fluid to flow into the second channel. A fourth loading port extends between the second well and the second channel. A second air outlet is adjacent to the second end of the second channel. The second air outlet allows an interior of the second channel to communicate with an environment external of the cartridge. It is intended for capillary action to cause the third fluid received in the third well to flow into the second channel through the third loading port and toward the second air outlet. At least a portion of the third fluid flowing through the second channel flows into the second well through the fourth loading port.

It is contemplated for the channel network to be a first channel network and for the cartridge to includes a second channel network. The second channel network is defined by a channel having first and second opposite ends. A first well is adjacent the first end of the channel of the second channel network. The first well of the second channel network is adapted for receiving a third fluid therein. A first loading port extends between the first well of the second channel network and the channel of the second channel network. The first loading port of the second channel network has a sufficient dimension to allow the third fluid to flow into the channel of the second channel network. A second well is disposed between the first and second ends of the channel of the second channel network. The second well of the second channel network is adapted for receiving a fourth fluid therein. A second loading port extends between the second well of the second channel network and the channel of the second channel network. The second loading port of the second channel network has a dimension to pin the fourth fluid in the second well of the second channel network.

The second channel network may be further defined by an air outlet adjacent to the second end of the second channel network. The air outlet of the second channel network allows an interior of the channel of the second channel network to communicate with an environment external of the cartridge. Capillary action causes the third fluid received in the first well of the second channel network to flow into the channel of the second channel network through the first loading port of the second channel network and toward the air outlet of the second channel network. At least a portion of the third fluid flowing through the channel of the second channel network flows into the second well of the second channel network through the second loading port of the second channel network.

Alternatively, the channel of the second channel network may communicate with the air outlet adjacent to the second end of the channel of the second channel network. The air outlet allows an interior of the channel of the second channel network to communicate with an environment external of the cartridge. Capillary action causes the third fluid received in the first well of the second channel network to flow into the channel of the second channel network through the first loading port of the second channel network and toward the air outlet. At least a portion of the third fluid flowing through the channel of the second channel network flows into the second well of the second channel network through the second loading port of the second channel network.

Alternatively, the channel is first channel and the channel network may also include a second channel having first and second opposite ends. A third well is disposed between the first and second ends of the second channel. The third well is adapted for receiving a third fluid therein. A third loading port extends between the third well and the second channel. The third loading port has a dimension to pin the third fluid in the third well. The first loading port communicates with the second channel adjacent the first end of the second channel.

The air outlet may communicate with the second end of the second channel, or alternatively, the air outlet may be a first air outlet and the channel network may include a second air outlet adjacent to the second end of the second channel. The second air outlet allows an interior of the second channel to communicate with an environment external of the cartridge. Capillary action causes the first fluid received in the second channel to flow into the second channel through the first loading port and toward the second air outlet. A length of the first channel between the first loading port and the second loading port is generally equal to a length of the second channel between the first loading port and the third loading port.

A microfluidic device may also include a frame having first and second sides and first and second ends. The cartridge may include first and second ends. A first connector is connected to the cartridge adjacent the first end of the cartridge/The first connector is removably connectable to the first side of the frame. A second connector is connected to the cartridge adjacent the second end of the cartridge. The second connector is removably connectable to the second side of the frame.

In accordance with a further aspect of the present invention, a microfluidic device for profiling biochemical samples types. A cartridge defines a channel network. The channel network includes a channel having first and second opposite ends. A first well communicating with the first end of the channel. The first well is adapted for receiving a first fluid therein. A second well is in communication with the channel through a loading port at a location between the first and second ends of the channel. The second well is adapted for receiving a second fluid therein. An air outlet is in communication with the channel at a location adjacent to the second end of the channel. The air outlet allows an interior of the channel to communicate with an environment external of the cartridge. Capillary action causes the first fluid received in the first well to flow into the channel toward the air outlet. The second loading port has a dimension to pin the second fluid in the second well. At least a portion of the first fluid flowing through the channel flows into the second well.

The channel may be a first channel, the loading port may be a first loading port, and the air outlet may a first air outlet. The channel network includes a second channel having first and second opposite ends. A third well communicates the first end of the second channel. The third well is adapted for receiving a third fluid therein. A second loading port extends between the second well and the second channel. A second air outlet is adjacent to the second end of the second channel. The second air outlet allows an interior of the second channel to communicate with an environment external of the cartridge. It is intended for capillary action to cause the third fluid received in the third well to flow into the second channel toward the air outlet. At least a portion of the third fluid flowing through the second channel flows into the second well through the second loading port.

It is contemplated for the channel network to be a first channel network and for the cartridge to further include a second channel network. The second channel network is defined by a channel having first and second opposite ends, a first well communicating with the channel of the second channel network at a location adjacent the first end of the channel of the second channel network and a second well communicating with the channel of the second channel network through a loading port at a location between the first and second ends of the channel of the second channel network. The first well of the second channel network is adapted for receiving a third fluid therein and the second well of the second channel network adapted for receiving a fourth fluid therein. The loading port of the second channel network has a dimension to pin the fourth fluid in the second well of the second channel network

The second channel network may also include an air outlet in communication with the channel of the second channel network at a location adjacent to the second end of the second channel network. The air outlet of the second channel network allows an interior of the channel of the second channel network to communicate with an environment external of the cartridge. Capillary action causes the third fluid received in the first well of the second channel network to flow into the channel of the second channel network toward the air outlet of the second channel network. At least a portion of the third fluid flowing through the channel of the second channel network flows into the second well of the second channel network through the loading port of the second channel network.

Alternatively, the channel of the second channel network may communicate with the air outlet of the first channel network at a location adjacent to the second end of the channel of the second channel network. The air outlet allows an interior of the channel of the second channel network to communicate with an environment external of the cartridge. Capillary action causes the third fluid received in the first well of the second channel network to flow into the channel of the second channel network toward the air outlet. At least a portion of the third fluid flowing through the channel of the second channel network flows into the second well of the second channel network through the loading port of the second channel network.

It is further contemplated for the channel to be a first channel and for the loading port to be a first loading port. In such configuration, the channel network may further include a second channel having first and second opposite ends. A third well is in communication with the second channel through a second loading port at a location between the first and second ends of the second channel. The third well is adapted for receiving a third fluid therein. The first well is in communication with the second channel at a location adjacent the first end of the second channel.

The air outlet may be in communication with the second end of the second channel, or alternatively, the air outlet may be a first air outlet and the channel network further includes a second air outlet in communication with the second channel at a location adjacent to the second end of the second channel. The second air outlet allows an interior of the second channel to communicate with an environment external of the cartridge. Capillary action causes the first fluid received in the second channel to flow into the second channel toward the second air outlet.

In accordance with a still further aspect of the present invention, a microfluidic device for profiling biochemical samples is provided. The microfluidic device includes a cartridge defining a channel network. The channel network includes a channel having first and second opposite ends. A first loading port is in communication with the channel. The first loading port is configured to allow introduction of a first fluid into the channel. A well is in communication with the channel through a second loading port and is located between the first loading port and the second end of the channel. The second well is adapted for receiving a second fluid therein. An air outlet is in communication with channel at a location adjacent to the second end of the channel. The air outlet allows an interior of the channel to communicate with an environment external of the cartridge. The second loading port has a dimension to pin the second fluid in the second well. The first fluid received in the first well flows into the channel toward the air outlet. At least a portion of the first fluid flowing through the channel flows into the second well through the second loading port.

The channel network may be a first channel network and the cartridge may further includes a second channel network. The second channel network is defined by a channel having first and second opposite ends; a first loading port in communication with the channel of the second channel network, and a well in communication with the channel of the second channel network through a second loading port and located between the first loading port of the second channel network and the second end of the channel of the second channel network. The first loading port of the second channel network is configured to allow introduction of a third fluid into the channel of the second channel network. The well of the second channel network is adapted for receiving a fourth fluid therein. The second loading port of the second channel network has a dimension to pin the fourth fluid in the second well of the second channel network.

The second channel network may also include an air outlet in communication with the channel of the second channel network at a location adjacent to the second end of the second channel network. The air outlet of the second channel network allows an interior of the channel of the second channel network to communicate with an environment external of the cartridge. Alternatively, the channel of the second channel network communicates with the air outlet of the first channel network at a location adjacent to the second end of the channel of the second channel network. The air outlet allows an interior of the channel of the second channel network to communicate with an environment external of the cartridge.

It is further contemplated for the channel to be a first channel and for the channel network to further include a second channel having first and second opposite ends. The second channel may be in communication with the first loading port. A second well is in communication with the second channel through a third loading port at a location between the first loading port and the second end of the second channel. The second well is adapted for receiving a third fluid therein.

The air outlet may be in communication with the communication with the second channel at a location adjacent the second end of the second channel. Alternatively, the air outlet may be a first air outlet and the channel network may further includes a second air outlet in communication with the second channel at a location adjacent to the second end of the second channel. The second air outlet allows an interior of the second channel to communicate with an environment external of the cartridge.

### BRIEF DESCRIPTION OF THE DRAWINGS

The drawings furnished herewith illustrate a preferred construction of the present invention in which the above advantages and features are clearly disclosed, as well as others which will be readily understood from the following description of the illustrated embodiment.

In the drawings:

FIG. 1 is a top plan view of a microfluidic device in accordance with the present invention;

FIG. 2 is an enlarged, top plan view showing a portion of the microfluidic device of FIG. 1;

FIG. 3 is a cross-sectional view of the microfluidic device of the present invention taken along line 3-3 of FIG. 2;

FIG. 4 is a cross-sectional view of the microfluidic device of the present invention taken along line 4-4 of FIG. 2;

FIG. 5 is a schematic view showing the microfluidic device of the present invention in a first operative step;

FIG. 6 is a schematic view showing the microfluidic device of the present invention in a second operative step;

FIG. 7 is a schematic view showing the microfluidic device of the present invention in a third operative step;

FIG. 8 is schematic view showing an alternate configuration of a channel network for the microfluidic device of the present invention;

FIG. 9 is a cross-sectional view of the channel network for the microfluidic device of the present invention taken along line 9-9 of FIG. 8;

FIG. 10 is a cross-sectional view of the channel network for the microfluidic device of the present invention taken along line 10-10 of FIG. 8;

FIG. 11 is a cross-sectional view of the channel network for the microfluidic device of the present invention taken along line 11-11 of FIG. 8;

FIG. 12 is a cross-sectional view of the channel network for the microfluidic device of the present invention taken along line 12-12 of FIG. 8;

FIG. 13 is a schematic view showing a first channel of the channel network of FIG. 8 in a first operative step;

FIG. 14 is a schematic view showing the first channel of the channel network of FIG. 8 in a second operative step;

FIG. 15 is a schematic view showing the first channel of the channel network of FIG. 8 in a third operative step;

FIG. 16 is a schematic view showing a second channel of the channel network of FIG. 8 in a first operative step;

FIG. 17 is a schematic view showing the second channel of the channel network of FIG. 8 in a second operative step;

FIG. 18 is a schematic view showing the second channel of the channel network of FIG. 8 in a third operative step;

FIG. 19 is a schematic view showing a third channel of the channel network of FIG. 8 in a first operative step;

FIG. 20 is a schematic view showing the third channel of the channel network of FIG. 8 in a second operative step;

FIG. 21 is a schematic view showing the third channel of the channel network of FIG. 8 in a third operative step;

FIG. 22 is schematic view showing a further alternate configuration of a channel network for the microfluidic device of the present invention;

FIG. 23 is a cross-sectional view of the channel network for the microfluidic device of the present invention taken along line 23-23 of FIG. 22;

FIG. 24 is a cross-sectional view of the channel network for the microfluidic device of the present invention taken along line 24-24 of FIG. 22;

FIG. 25 is a cross-sectional view of the channel network for the microfluidic device of the present invention taken along line 25-25 of FIG. 22;

FIG. 26 is a cross-sectional view of the channel network for the microfluidic device of the present invention taken along line 26-26 of FIG. 22;

FIG. 27 is a cross-sectional view of the channel network for the microfluidic device of the present invention taken along line 27-27 of FIG. 22;

FIG. 28 is a cross-sectional view of the channel network for the microfluidic device of the present invention taken along line 28-28 of FIG. 22;

FIG. 29 is a cross-sectional view of the channel network for the microfluidic device of the present invention taken along line 29-29 of FIG. 22;

FIG. 30 is a schematic view showing the channel network of FIG. 22 in a first operative step;

FIG. 31 is a schematic view showing the channel network of FIG. 22 in a second operative step;

FIG. 32 is a schematic view showing the channel network of FIG. 22 in a third operative step;

FIG. 33 is a schematic view showing the channel network of FIG. 22 in a fourth operative step;

FIG. 34 is a schematic view showing the channel network of FIG. 22 in a fifth operative step;

FIG. 35 is schematic view showing a still further alternate configuration of a channel network for the microfluidic device of the present invention;

FIG. 36 is a cross-sectional view of the channel network for the microfluidic device of the present invention taken along line 36-36 of FIG. 35;

FIG. 37 is a cross-sectional view of the channel network for the microfluidic device of the present invention taken along line 37-37 of FIG. 35;

FIG. 38 is a schematic view showing an exemplary channel of the channel network of FIG. 35 in a first operative step;

FIG. 39 is a schematic view showing the exemplary channel of the channel network of FIG. 35 in a second operative step;

FIG. 40 is a schematic view showing the exemplary channel of the channel network of FIG. 35 in a third operative step;

FIG. 41 is a top plan view of an alternate configuration of a microfluidic device in accordance with the present invention;

FIG. 42 is an end view of the microfluidic device of FIG. 41;

FIG. 43 is a bottom plan view a cartridge for the microfluidic device of the present invention; and

FIG. 44 is a top plan view of the cartridge for the microfluidic device of the present invention.

### DETAILED DESCRIPTION OF THE DRAWINGS

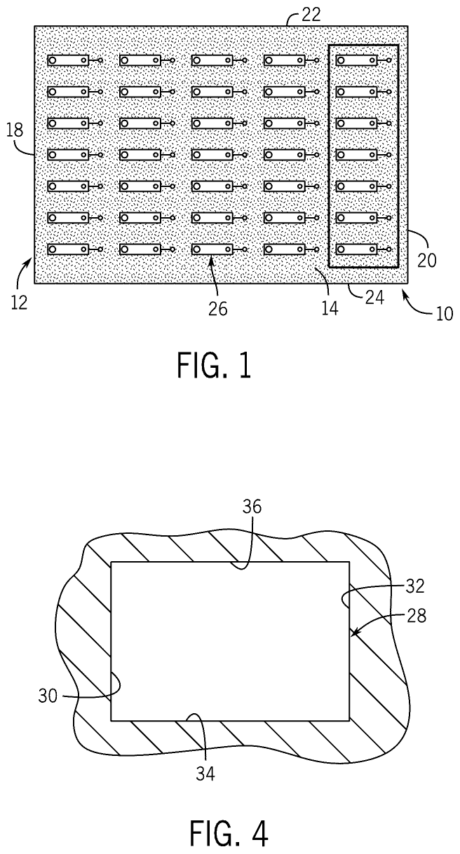

Referring to FIG. 1, a microfluidic device for profiling biochemical samples, such as biochemical analytes and/or cell types, is generally designated by the reference numeral 10. By way of example, microfluidic device 10 may take the form of single cartridge 12 corresponding in size and shape to a conventional 384 well plate. However, as hereinafter described, cartridge 12 may be fabricated in other sizes and shapes without deviating from the scope of the scope of the present invention. Referring to back to FIG. 1, cartridge 12 is defined by a generally flat, upper surface 14 interconnected to a generally flat, lower surface 16, FIG. 3, by first and second ends 18 and 20, respectively, and first and second sides 22 and 24, respectively. An array of one or more channel networks (e.g. channel networks 26, 26a, 26b and 26b) are formed in cartridge 12, as hereinafter described.

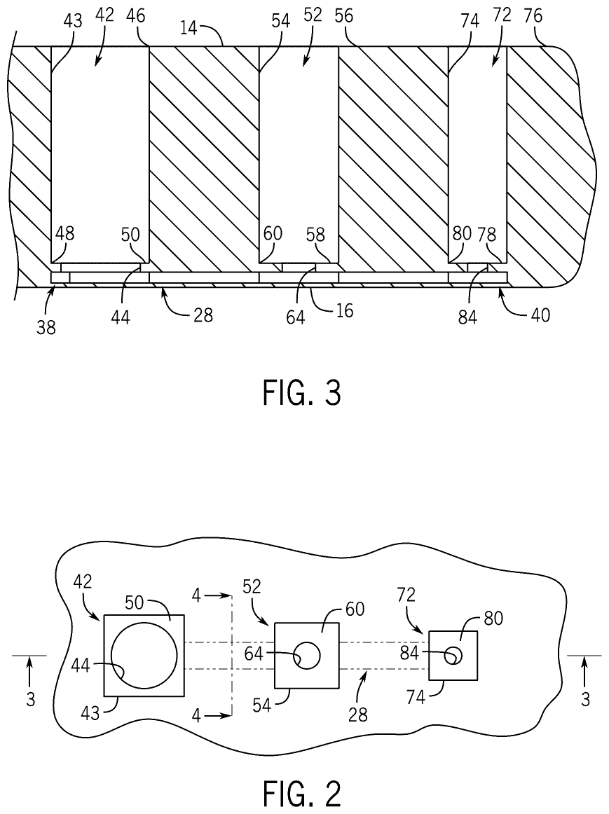

Referring to FIGS. 2-7, by way of example, channel network 26 may include central channel 28 extending through cartridge 12 between upper and lower surfaces 14 and 16, respectively, thereof. Central channel 28 may extend along a longitudinal axis, be nonlinear, be serpentine or be a combination thereof. As best seen in FIG. 4, central channel 28 extends along a longitudinal axis and is defined by first and second spaced sidewalls 30 and 32, respectively, interconnecting bottom wall 34 and upper wall 36. Central channel 28 further includes opposite, first and second ends 38 and 40, respectively, FIG. 3.

First well 42 is formed in upper surface 14 at a location adjacent to and overlapping first end 38 of central channel 28. First well 42 is defined by inner surface 43 having an upper edge 46 intersecting upper surface 14 and a lower edge 48, and a lower surface 50 extending radially inward from lower edge 48. While first well 42 has a generally rectangular cross-section, other configurations are possible without deviating from scope of the present invention. First loading port 44 extends between lower surface 50 partially defining first well 42 and upper wall 36 partially defining central channel 28 such that first well 42 communicates with central channel 28 at a location adjacent first end 38 of central channel 38. First loading port 44 has a generally circular configuration and a diameter of sufficient dimension (e.g. in the range 1 to 2 millimeters (mm)) to allow loading of central channel 28, as hereinafter described. While first loading port 44 is depicted as having a generally circular configuration, it can be understood that other configurations are possible without deviating from scope of the present invention.

Second well 52 is formed in upper surface 14 at a location aligned with central channel 28 between first and second ends 38 and 40, respectively. Second well 52 is defined by an inner surface 54 having an upper edge 56 intersecting upper surface 14 and a lower edge 58, and a lower surface 60 extending radially inward from lower edge 58. While second well 52 has a generally rectangular cross-section, other configurations are possible without deviating from scope of the present invention.

Second loading port 64 extends between lower surface 60 partially defining second well 52 and upper wall 36 partially defining central channel 28 such that second well 52 communicates with central channel 28 at a location between first and second ends 38 and 40, respectively, of central channel 38. Second loading port 44 has a generally circular configuration and a diameter of a dimension sufficient to pin fluid received in second well 52 and retain the fluid therein (e.g. in the range of 10-1000 microns), while allowing fluid received in central channel 28 to flow into second well 52, as hereinafter described. While second loading port 64 is depicted as having a generally circular configuration, it can be understood that other configurations are possible without deviating from scope of the present invention.

Third well 72 is formed in upper surface 14 at a location adjacent to and overlapping second end 40 of central channel 28. Third well 72 is defined by inner surface 74 having an upper edge 76 intersecting upper surface 14 and a lower edge 78, and a lower surface 80 extending radially inward from lower edge 78. While first well 72 has a generally rectangular cross-section, other configurations are possible without deviating from scope of the present invention. Air outlet 84 extends between lower surface 80 partially defining third well 72 and upper wall 36 partially defining central channel 28 such that third well 72 communicates with central channel 28 at a location adjacent first end 38 of central channel 28. Air outlet 84 has a generally circular configuration and a diameter of a dimension sufficient to pin fluid in central channel 28 and prevent the fluid from passing into third well 72 (e.g. in the range of 10-500 microns). While air outlet 84 is depicted as having a generally circular configuration, it can be understood that other configurations are possible without deviating from scope of the present invention.

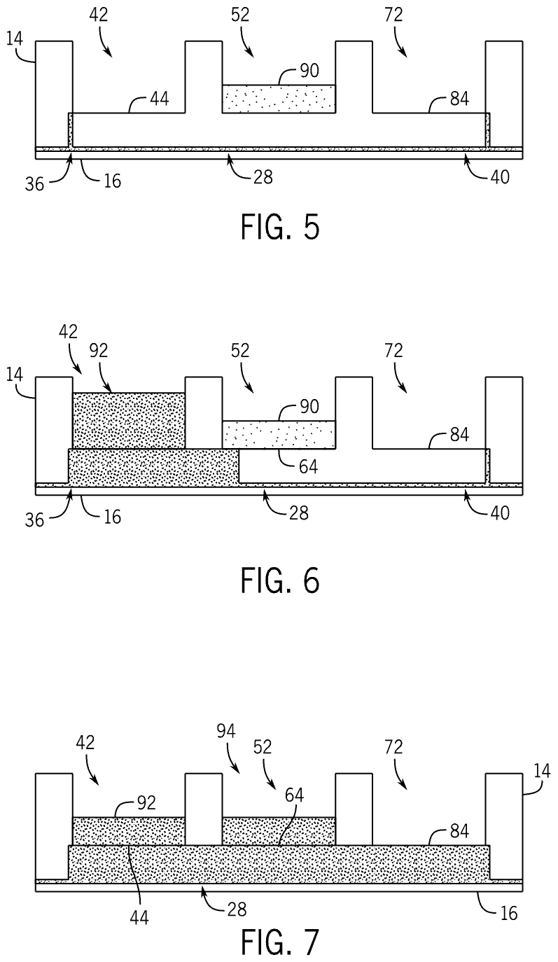

In operation, a fluid, e.g. reagent buffer 90, is loaded in second well 52. The diameter of second loading port 64 is sufficient to pin reagent buffer 90 in second well 52 and retain reagent buffer 90 therein, FIG. 5. Thereafter, a fluid, e.g. analyte solution 92, is loaded into first well 42, FIG. 6. First loading port 44 is of sufficient dimension to allow analyte solution 92 to flow into central channel 28, FIG. 7. Capillary action causes analyte solution 92 to flow through central channel 28 toward air outlet 84, thereby urging air out of central channel 28 through air outlet 84. As noted above, air outlet 84 has a diameter of a dimension sufficient to pin analyte solution 92 in central channel 28 and prevent analyte solution 94 from passing into third well 72 through air outlet 84. With analyte solution 92 pinned at air outlet 84, analyte solution 92 flowing through central channel 28 is directed into second well 52 through second loading port 64, wherein analyte solution 92 and reagent buffer 90 mix via diffusion. The mixture, designated by the reference numeral 94, may be removed for additional analysis, if so desired.

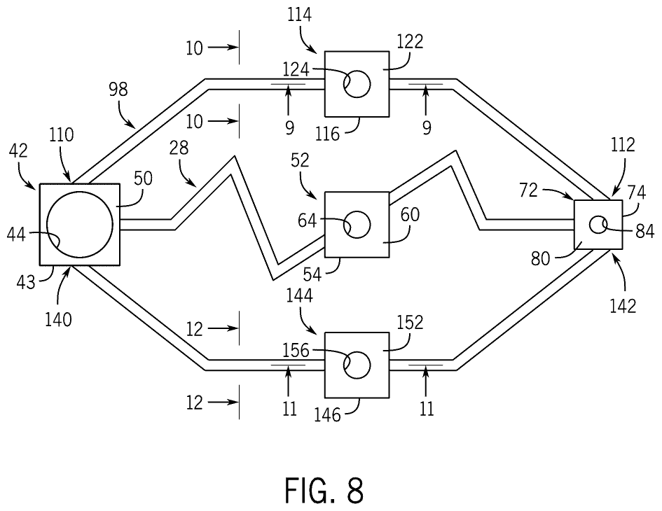

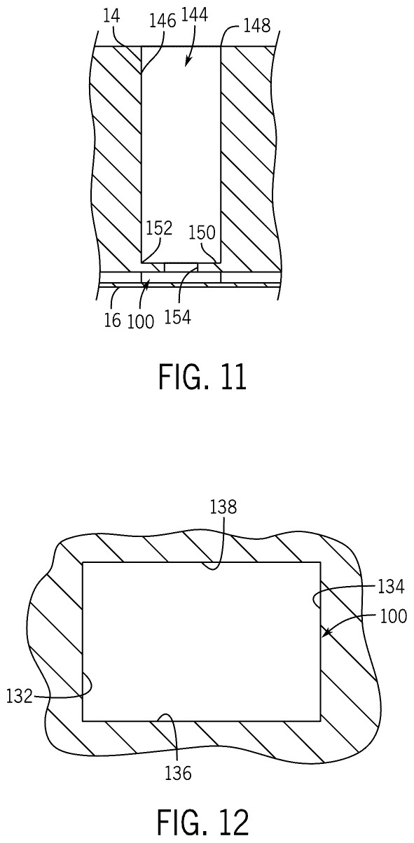

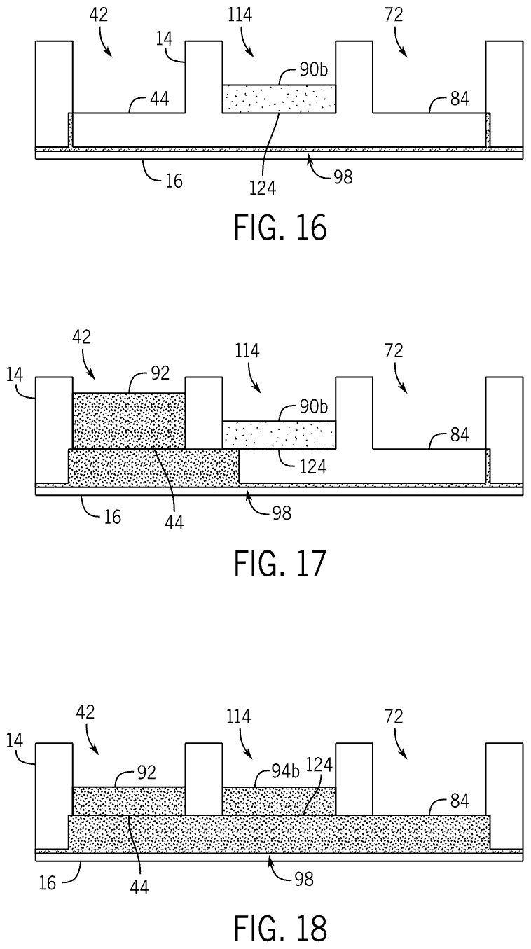

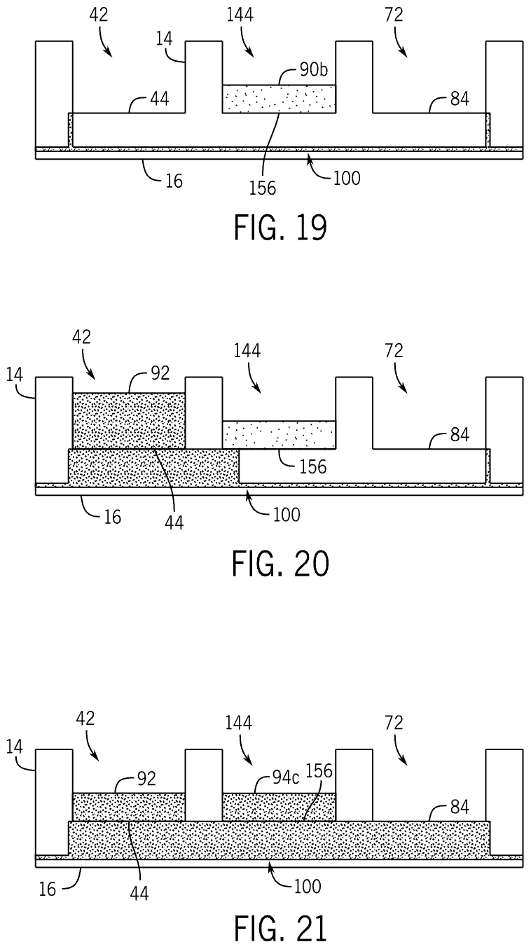

Referring to FIGS. 8-21, an alternate channel network is generally designated by the reference numeral 26a. As hereinafter described, channel network 26a incorporates elements/components found in channel network 26. As such, common reference characters are used to identify these common elements/components.

In addition to central channel 28, channel network 26a includes a plurality of additional channels, e.g., second channel 98 and third channel 100, which extend between first loading port 44 to air outlet 84. More specifically, second channel 98 extends through cartridge 12 between upper and lower surfaces 14 and 16, respectively, thereof. Second channel 98 is defined by first and second spaced sidewalls 102 and 104, respectively, interconnecting bottom wall 106 and upper wall 108, FIG. 10. Second channel 98 further includes opposite, first and second ends 110 and 112, respectively. First end 110 of second channel 98 is in communication with first loading port 44 and second end 112 of second channel 98 is in communication with air outlet 84.

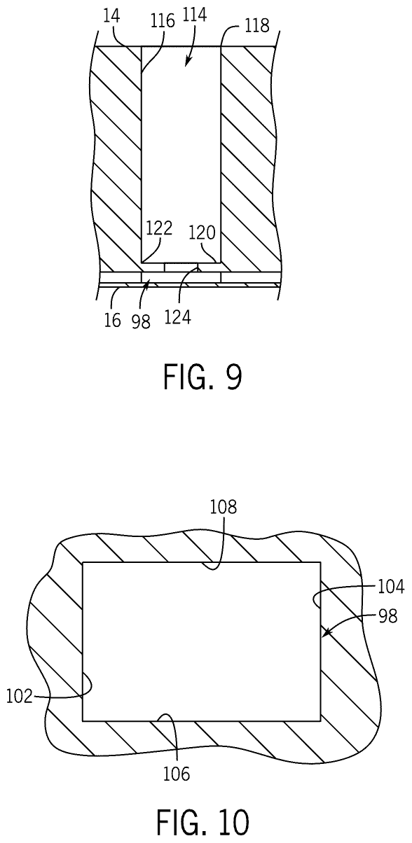

As best seen in FIG. 9, fourth well 114 is formed in upper surface 14 of cartridge 12 at a location aligned with second channel 98 between first and second ends 110 and 112, respectively, thereof. Fourth well 114 is defined by an inner surface 116 having an upper edge 118 intersecting upper surface 14 and a lower edge 120, and a lower surface 122 extending radially inward from lower edge 120. While fourth well 114 has a generally rectangular cross-section, other configurations are possible without deviating from scope of the present invention.

Third loading port 124 extends between lower surface 122 partially defining fourth well 114 and upper wall 108 partially defining second channel 98 such that fourth well 114 communicates with second channel 98 at a location between first and second ends 110 and 112, respectively, of second channel 98. Third loading port 124 has a generally circular configuration and a diameter of a dimension sufficient to pin fluid received in fourth well 114 and retain the fluid therein, while allowing fluid received in second channel 98 to flow into fourth well 114, as hereinafter described. While third loading port 124 is depicted as having a generally circular configuration, it can be understood that other configurations are possible without deviating from scope of the present invention.

Referring to FIGS. 8 and 11-12, third channel 100 extends through cartridge 12 between upper and lower surfaces 14 and 16, respectively, thereof. Third channel 100 is defined by first and second spaced sidewalls 132 and 134, respectively, interconnecting bottom wall 136 and upper wall 138. Third channel 100 further includes opposite, first and second ends 140 and 142, respectively. First end 140 of third channel 100 is in communication with first loading port 44 and second end 142 of third channel 100 is in communication with air outlet 84.

Fifth well 144 is formed in upper surface 14 of cartridge 12 at a location aligned with third channel 100 between first and second ends 140 and 142, respectively, thereof. Fifth well 144 is defined by an inner surface 146 having an upper edge 148 intersecting upper surface 14 and a lower edge 150, and a lower surface 152 extending radially inward from lower edge 150. While fourth well 144 has a generally rectangular cross-section, other configurations are possible without deviating from scope of the present invention.

Fourth loading port 154 extends between lower surface 152 partially defining fifth well 144 and upper wall 138 partially defining third channel 100 such that fifth well 144 communicates with third channel 100 at a location between first and second ends 140 and 142, respectively, of third channel 100. Fourth loading port 154 has a generally circular configuration and a diameter of a dimension sufficient to pin fluid received in fifth well 144 and retain the fluid therein, while allowing fluid received in third channel 100 to flow into fifth well 44, as hereinafter described. While fourth loading port 154 is depicted as having a generally circular configuration, it can be understood that other configurations are possible without deviating from scope of the present invention.

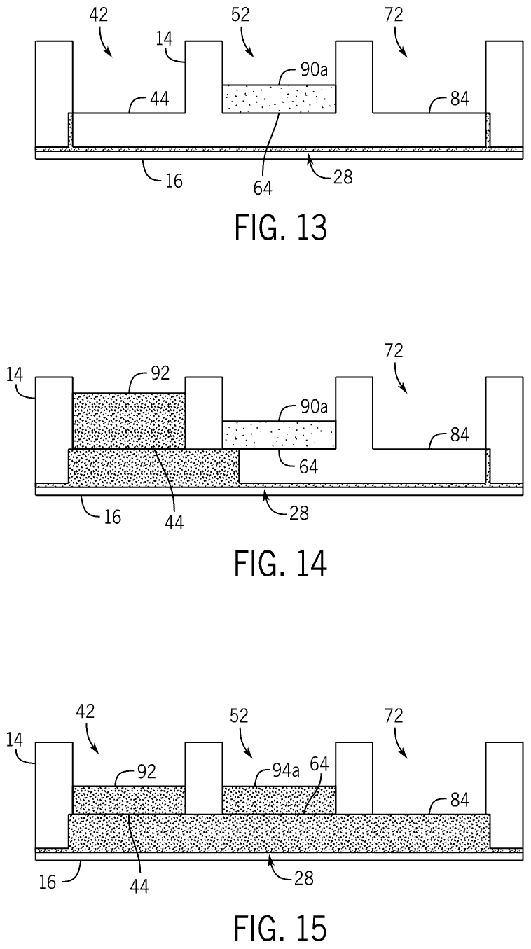

In operation, fluids, e.g. the same or different reagent buffers 90a-90c, are loaded into second well 52, fourth well 114 and fifth well 144, respectively. The diameters of second loading port 64, third loading port 124 and fourth loading port 154 is sufficient to pin reagent buffers 90a-90c, respectively, in corresponding second well 52, fourth well 114 and fifth well 144, respectively, and retain reagent buffers 90a-90c therein, FIGS. 13, 16 and 19. Thereafter, a fluid, e.g. analyte solution 92, is loaded into first well 42, FIGS. 14, 17 and 20. First loading port 44 is of sufficient dimension to allow analyte solution 92 to flow into central channel 28, second channel 98 and third channel 100. Capillary action causes analyte solution 92 to flow through central channel 28 toward air outlet 84, thereby urging air out of central channel 28 through air outlet 84. Simultaneously, capillary action causes analyte solution 92 to flow through second channel 98 toward air outlet 84, thereby urging air out of central channel 28 through air outlet 84, and through third channel 100 toward air outlet 84, thereby urging air out of central channel 28 through air outlet 84.

In order to prevent cross-contamination and potential backflow between central channel 28, second channel 98 and third channel 100, and to generate simultaneous flow through central channel 28, second channel 98 and third channel 100, it is contemplated for: 1) the length of central channel 28 between first loading port 44 and second loading port 64 to be generally equal to the length of second channel 98 between first loading port 44 and third loading port 124 and to the length of third channel 100 between first loading port 44 and fourth loading port 154; and 2) the length of central channel 28 between second loading port 64 and air outlet 84 to be generally equal to the length of second channel 98 between third loading port 124 and air outlet 84 and to the length of third channel 100 between first loading port 44 and fourth loading port 154. As such, central channel 28, second channel 98 and third channel 100 may have various configurations (e.g. extend along a longitudinal axis, be nonlinear, be serpentine or be a combination thereof). In addition, the configurations of central channel 28, second channel 98 and third channel 100 may be designed and arranged so to optimize the number of channel networks 26 in the array of channel networks 26 within cartridge 12.

As noted above, air outlet 84 has a diameter of a dimension sufficient to pin analyte solution 92 in central channel 28, second channel 98 and third channel 100, thereby preventing analyte solution 92 from passing into third well 72 through air outlet 84. With analyte solution 92 pinned at air outlet 84, analyte solution 92 flowing through central channel 28 is directed into second well 52 through second loading port 64, wherein analyte solution 92 and reagent buffer 90a mix via diffusion, FIG. 15; analyte solution 92 flowing through second channel 98 is directed into fourth well 114 through third loading port 124, wherein analyte solution 92 and reagent buffer 90b mix via diffusion, FIG. 18; and analyte solution 92 flowing through third channel 100 is directed into fifth well 144 through fourth loading port 154, wherein analyte solution 92 and reagent buffer 90c mix via diffusion, FIG. 21. The mixtures, designated by the reference numerals 94a, 94b and 94c in second well 52, fourth well 114 and fifth well 144, respectively, may be removed for additional analysis, if so desired.

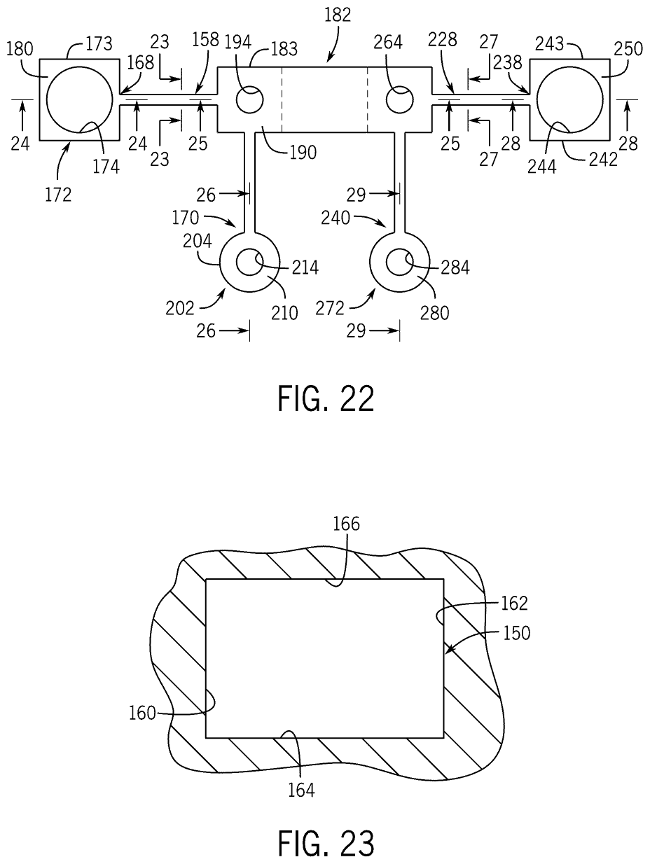

Referring to FIGS. 22-30, a still further alternate configuration a channel network is generally designated by the reference numeral 156. Channel network 156 includes first channel 158 extending through cartridge 12 between upper and lower surfaces 14 and 16, respectively, thereof. First channel 158 is defined by first and second spaced sidewalls 160 and 162, respectively, interconnecting bottom wall 164 and upper wall 166. First channel 158 further includes opposite, first and second ends 168 and 170, respectively.

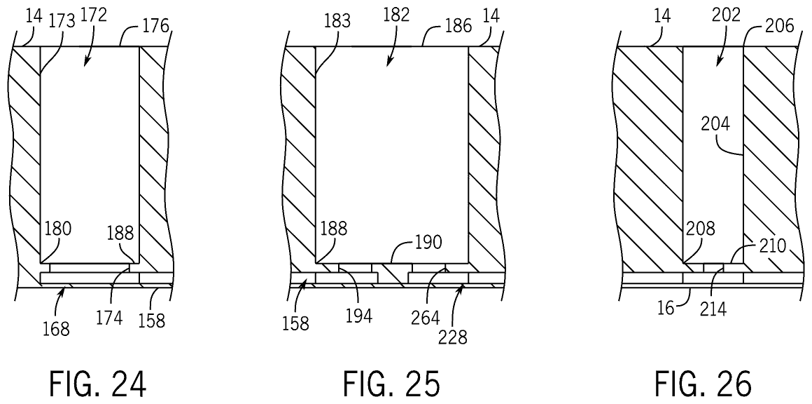

As best seen in FIGS. 22 and 24, first well 172 is formed in upper surface 14 at a location adjacent to and overlapping first end 168 of first channel 158. First well 172 is defined by inner surface 173 having an upper edge 176 intersecting upper surface 14 and a lower edge 188, and a lower surface 180 extending radially inward from lower edge 188. While first well 172 has a generally rectangular cross-section, other configurations are possible without deviating from scope of the present invention. First loading port 174 extends between lower surface 180 partially defining first well 172 and upper wall 166 partially defining first channel 158 such that first well 172 communicates with first channel 158 at a location adjacent first end 168 of first channel 158. First loading port 174 has a generally circular configuration and a diameter of sufficient dimension to allow loading of first channel 158, as hereinafter described. While first loading port 174 is depicted as having a generally circular configuration, it can be understood that other configurations are possible without deviating from scope of the present invention.

Referring to FIGS. 22 and 25, second well 182 is formed in upper surface 14 at a location aligned with first channel 158 between first and second ends 168 and 170, respectively. Second well 182 is defined by an inner surface 183 having an upper edge 186 intersecting upper surface 14 and a lower edge 188, and a lower surface 190 extending radially inward from lower edge 188. While second well 182 has a generally rectangular cross-section, other configurations are possible without deviating from scope of the present invention.

Second loading port 194 extends between lower surface 190 partially defining second well 182 and upper wall 166 partially defining first channel 158 such that second well 182 communicates with first channel 158 at a location between first and second ends 168 and 170, respectively, of first channel 158. Second loading port 194 has a generally circular configuration and a diameter of a dimension sufficient to pin fluid received in second well 182 and retain the fluid therein, while allowing fluid received in first channel 158 to flow into second well 182, as hereinafter described. While second loading port 194 is depicted as having a generally circular configuration, it can be understood that other configurations are possible without deviating from scope of the present invention.

Referring to FIGS. 22 and 26, third well 202 is formed in upper surface 14 at a location adjacent to and overlapping second end 170 of first channel 158. Third well 202 is defined by inner surface 204 having an upper edge 206 intersecting upper surface 14 and a lower edge 208, and a lower surface 210 extending radially inward from lower edge 208. While third well 202 has a generally circular cross-section, other configurations are possible without deviating from scope of the present invention. Air outlet 214 extends between lower surface 210 partially defining third well 202 and upper wall 166 partially defining first channel 158 such that third well 202 communicates with first channel 158 at a location adjacent second end 170 of first channel 158. Air outlet 214 has a generally circular configuration and a diameter of a dimension sufficient to pin fluid in first channel 158 and prevent the fluid from passing into third well 202. While air outlet 214 is depicted as having a generally circular configuration, it can be understood that other configurations are possible without deviating from scope of the present invention.

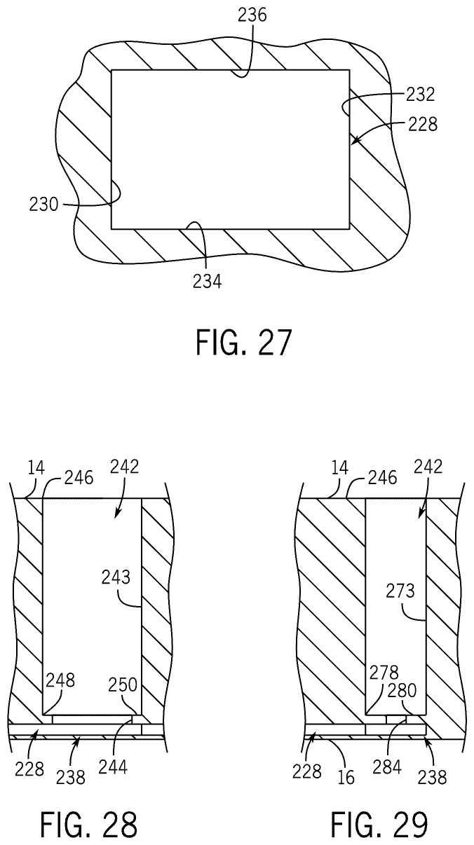

Channel network 26b further includes second channel 228 extending through cartridge 12 between upper and lower surfaces 14 and 16, respectively, thereof. Second channel 228 is defined by first and second spaced sidewalls 230 and 232, respectively, interconnecting bottom wall 234 and upper wall 236, FIG. 27. Second channel 228 further includes opposite, first and second ends 238 and 240, respectively.

Referring to FIGS. 22 and 28, fourth well 242 is formed in upper surface 14 at a location adjacent to and overlapping first end 238 of second channel 228. Fourth well 242 is defined by inner surface 243 having an upper edge 246 intersecting upper surface 14 and a lower edge 248, and a lower surface 250 extending radially inward from lower edge 248. While fourth well 242 has a generally rectangular cross-section, other configurations are possible without deviating from scope of the present invention. Third loading port 244 extends between lower surface 250 partially defining fourth well 242 and upper wall 236 partially defining second channel 228 such that fourth well 242 communicates with fourth channel 228 at a location adjacent first end 238 of second channel 228. Third loading port 244 has a generally circular configuration and a diameter of sufficient dimension to allow loading of second channel 228, as hereinafter described. While third loading port 244 is depicted as having a generally circular configuration, it can be understood that other configurations are possible without deviating from scope of the present invention.

Referring back to FIGS. 22 and 25, fourth loading port 264 extends between lower surface 190 partially defining second well 182 and upper wall 236 partially defining second channel 228 such that second well 152 communicates with second channel 228 at a location between first and second ends 238 and 240, respectively, of second channel 228. Fourth loading port 264 has a generally circular configuration and a diameter of a dimension sufficient to pin fluid received in second well 182 and retain the fluid therein, while allowing fluid received in second channel 228 to flow into second well 182, as hereinafter described. While fourth loading port 264 is depicted as having a generally circular configuration, it can be understood that other configurations are possible without deviating from scope of the present invention.

As best seen in FIGS. 22 and 29, fifth well 272 is formed in upper surface 14 at a location adjacent to and overlapping second end 240 of second channel 228. Fifth well 272 is defined by inner surface 273 having an upper edge 276 intersecting upper surface 14 and a lower edge 278, and a lower surface 280 extending radially inward from lower edge 278. While fifth well 272 has a generally circular cross-section, other configurations are possible without deviating from scope of the present invention. Air outlet 284 extends between lower surface 280 partially defining fifth well 272 and upper wall 236 partially defining second channel 228 such that fifth well 272 communicates with second channel 228 at a location adjacent second end 240 of second channel 228. Air outlet 284 has a generally circular configuration and a diameter of a dimension sufficient to pin fluid in second channel 228 and prevent the fluid from passing into fifth well 272. While air outlet 284 is depicted as having a generally circular configuration, it can be understood that other configurations are possible without deviating from scope of the present invention.

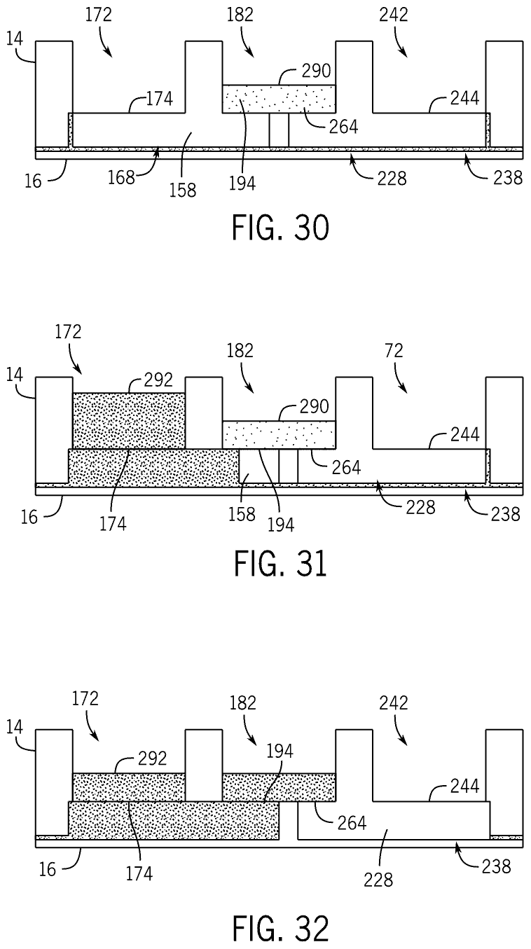

Referring to FIGS. 30-34, in operation, a first fluid, e.g. first reagent buffer 290, is loaded in second well 182. The diameters of second loading port 194 and fourth loading port 264 are sufficient to pin first reagent buffer 290 in second well 182 and retain first reagent buffer 290 therein. Thereafter, a first fluid, e.g. first analyte solution 292 is loaded into first well 172, FIG. 30. First loading port 174 is of sufficient dimension to allow first analyte solution 292 to flow into first channel 158, FIG. 31. Capillary action causes first analyte solution 292 to flow through first channel 158 toward air outlet 214, thereby urging air out of first channel 158 through air outlet 214. As noted above, air outlet 214 has a diameter of a dimension sufficient to pin first analyte solution 292 in first channel 158 and prevent first analyte solution 292 from passing into third well 72 through air outlet 214. With first analyte solution 292 pinned at air outlet 214, first analyte solution 292 flowing through first channel 158 is directed into second well 182 through second loading port 194, wherein first analyte solution 292 and first reagent buffer 290 mix via diffusion, FIG. 32.

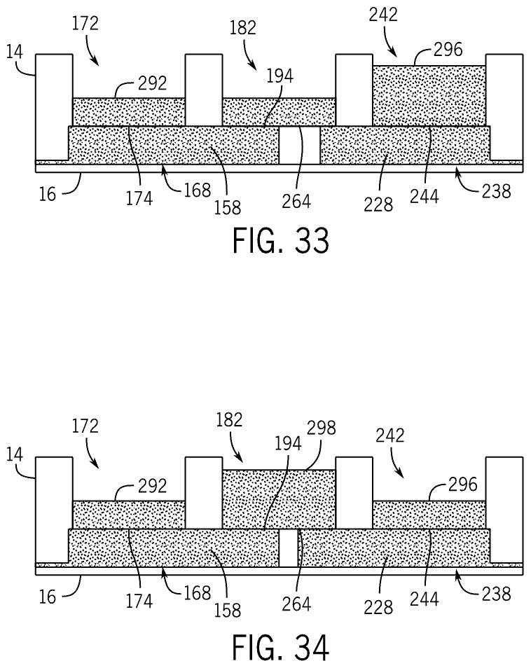

Either simultaneously or after first reagent buffer 290 and first analyte solution 292 are loaded into second well 182 and first well 172, respectively, a second fluid, e.g. second analyte solution 296, is loaded into fourth well 242, FIG. 33. Fourth loading port 264 is of sufficient dimension to allow second analyte solution 296 to flow into second channel 228. Capillary action causes second analyte solution 296 to flow through second channel 228 toward air outlet 284, thereby urging air out of second channel 228 through air outlet 284. As noted above, air outlet 284 has a diameter of a dimension sufficient to pin second analyte solution 296 in first channel 228 and prevent second analyte solution 296 from passing into fifth well 272 through air outlet 284. With second analyte solution 296 pinned at air outlet 284, second analyte solution 296 flowing through second channel 228 is directed into second well 182 through fourth loading port 264, wherein second analyte solution 296 mixes with first analyte solution 292 and first reagent buffer 290 via diffusion to form mixture 298, FIG. 34. Mixture 298 may be removed from second well 182 for additional analysis, if so desired.

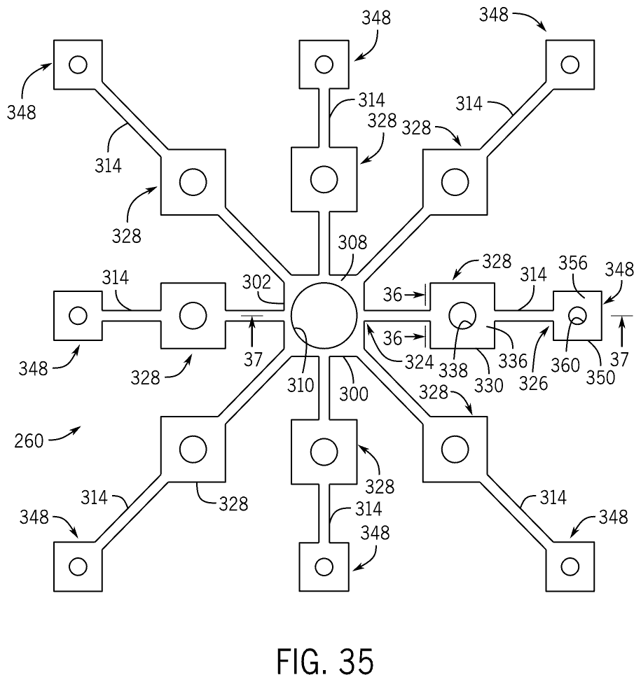

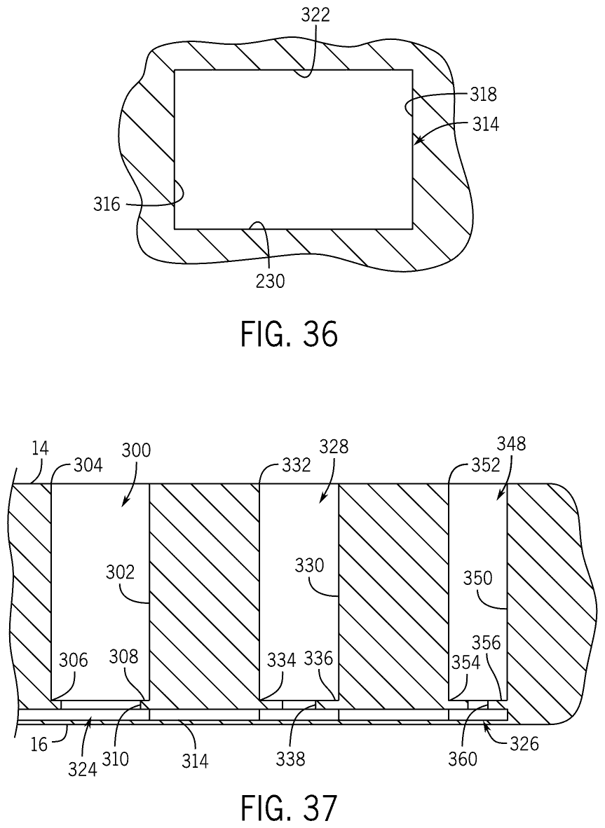

Referring to FIGS. 35-40, a still further alternate configuration of a channel network is generally designated by the reference numeral 26c. Channel network 26c includes central well 300 is formed in upper surface 14, FIG. 37. Central well 300 is defined by inner surface 302 having an upper edge 304 intersecting upper surface 14 and a lower edge 306, and a lower surface 308 extending radially inward from lower edge 306. While central well 300 has a generally rectangular cross-section, other configurations are possible without deviating from scope of the present invention. Central loading port 310 extends through lower surface 308 partially defining central well 300, as hereinafter described. Central loading port 310 has a generally circular configuration and a diameter of sufficient dimension to allow fluid therein to pass therethrough, as hereinafter described. While central loading port 310 is depicted as having a generally circular configuration, it can be understood that other configurations are possible without deviating from scope of the present invention.

Channel network 26c further includes a plurality of channels 314 extending through cartridge 12 between upper and lower surfaces 14 and 16, respectively, thereof. Each channel 314 is identical in structure and as such, the following description is understood to describe each channel 314. Channel 314 may extend along a longitudinal axis, have angled portions, be serpentine or be a combination thereof. In the embodiment depicted in FIG. 35, the plurality of channels 314 are circumferentially spaced about and extending radially outward from central loading port 310. More specifically, each channel 314 extends along a longitudinal axis and is defined by first and second spaced sidewalls 316 and 318, respectively, interconnecting bottom wall 320 and upper wall 322. Each channel 314 further includes first end 324 in communication with central loading port 310 and an opposite second end 326.

Loading wells 328 are formed in upper surface 14 at a location aligned with a corresponding one of the plurality of channels 314 between first and second ends 324 and 326, respectively. Each loading well 328 is identical in structure, and as such, the following description is understood to describe each loading well 328. Loading well 328 is defined by an inner surface 330 having an upper edge 332 intersecting upper surface 14 and a lower edge 334, and a lower surface 336 extending radially inward from lower edge 334. While each loading well 328 has a generally rectangular cross-section, other configurations are possible without deviating from scope of the present invention.

Loading ports 338 extend between lower surfaces 336 partially defining loading wells 328 and upper walls 322 partially defining corresponding channels 314 such that each loading well 328 communicates with a corresponding one of the plurality of channels 314 at a location between first and second ends 324 and 326, respectively, thereof. Loading ports 338 have a generally circular configurations and diameters of a dimension sufficient to pin fluids received in corresponding loading wells 338 and retain the fluids therein, while allowing the fluids received in corresponding channels 314 to flow into loading ports 338, as hereinafter described. While loading ports 338 are depicted as having a generally circular configuration, it can be understood that other configurations are possible without deviating from scope of the present invention.

Air outlet wells 348 are formed in upper surface 14 at locations adjacent to and overlapping second ends 326 of corresponding channels 314. Each air outlet well 348 is identical in structure, and as such, the following description is understood to describe each air outlet well 348. Each air outlet well 348 is defined by inner surface 350 having an upper edge 352 intersecting upper surface 14, a lower edge 354, and a lower surface 356 extending radially inward from lower edge 354. While each air outlet well 348 has a generally rectangular cross-section, other configurations are possible without deviating from scope of the present invention.

Air outlets 360 extends between lower surfaces 356 partially defining air outlet wells 348 and upper walls 322 partially defining channels 314 such that each air outlet wells 348 communicates with corresponding channels 314 at locations adjacent second end 326 of corresponding channels 314. Each air outlet 360 has a generally circular configuration and a diameter of a dimension sufficient to pin fluid in corresponding channel 314 and prevent the fluid from passing into corresponding air outlet well 348. While each air outlet 348 is depicted as having a generally circular configuration, it can be understood that other configurations are possible without deviating from scope of the present invention.

In order to prevent cross-contamination and potential backflow between channel 100, and to generate simultaneous fluid flow through channels 314, it is contemplated for: 1) the lengths of each channel 314 between central loading port 310 and loading port 338 to be generally equal; and 2) the lengths of each channel 314 between loading port 338 and air outlet 360 to be generally equal. Further, it is contemplated for the configurations to be designed and arranged so to optimize the number of channel networks 26b in the array of channel networks 26 within cartridge 12. As such, channels 314 may have different configurations (e.g. extend along a longitudinal axis, be nonlinear, be serpentine or be a combination thereof) without deviating from the scope of the present invention.

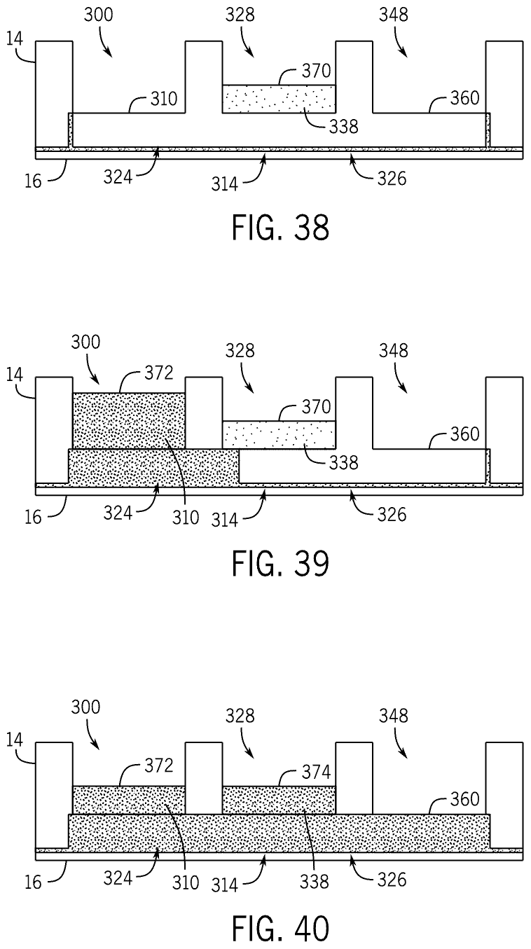

In operation, one or more fluids, e.g. reagent buffers 370, are loaded into loading wells 328, FIG. 38. The diameters of loading port 328 are sufficient to pin reagent buffers 370 in corresponding loading wells 328 and retain reagent buffers 370 therein. Thereafter, a fluid, e.g. analyte solution 372, is loaded into central well 300. Central loading port 310 is of sufficient dimension to allow analyte solution 372 to flow into channels 314, FIG. 39. Capillary action causes analyte solution 92 to flow simultaneously through channels 314 toward air outlet 360, thereby urging air out of channels 314 through air outlets 360. As noted above, air outlets 360 have a diameter of a dimension sufficient to pin analyte solution 372 in channels 314 and prevent analyte solution 372 from passing into air outlet wells 348 through corresponding air outlets 360. With analyte solution 372 pinned at air outlets 360, analyte solution 372 flowing through channels 314 is directed into loading wells 328 through corresponding loading ports 338, wherein analyte solution 372 and reagent buffers therein mix via diffusion, FIG. 40. The mixture, designated by the reference numeral 374, may be removed for additional analysis, if so desired.

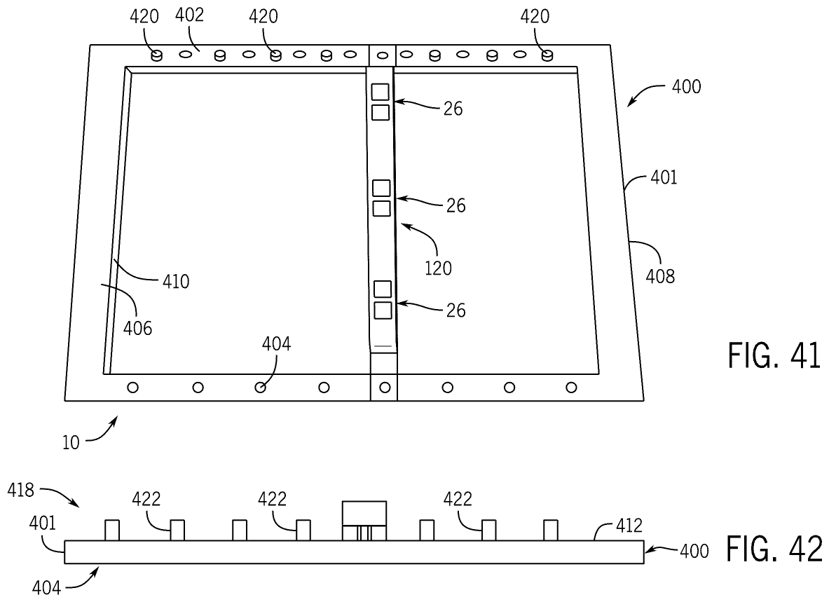

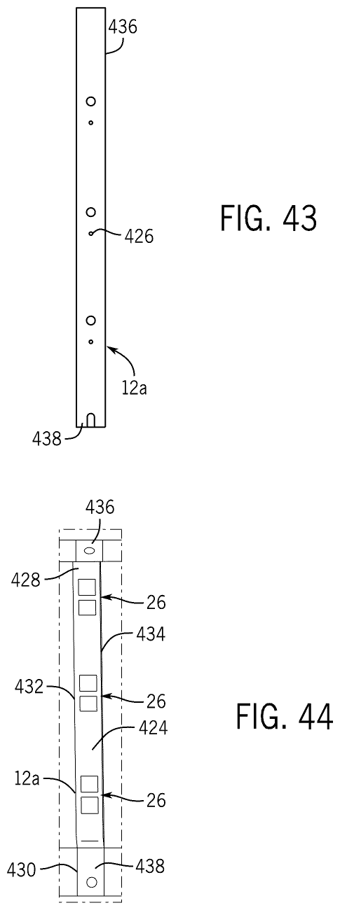

Referring to FIGS. 41-44, microfluidic device 10 may include frame 400 having an outer periphery 401 corresponding in size and shape to the outer periphery of a conventional 384 well plate. Frame 400 includes first and second spaced, generally parallel, side members 402 and 404, respectively, interconnected by first and second spaced, generally parallel, end members 406 and 408, respectively. Outer periphery 401 and inner edge 410 of frame 400 interconnect first and second sides 412 and 414, respectively, of frame 400. Frame 400 further includes a first set of connection pins 416 and a second set of connection pins 418. Each connection pin 420 of the first set of connection pins 416 projects from first side 412 of frame 400 along first side member 402. Connection pins 420 of the first set of connection pins 416 are axially spaced form each other and lie along a first axis. Similarly, each connection pin 422 of the second set of connection pins 418 projects from first side 412 of frame 400 along second side member 404. Connection pins 422 of the second set of connection pins 418 are axially spaced form each other and lie along a second axis, generally parallel to the first axis.

It is intended for each connection pin 420 of the first set of connection pins 416 to be transversely aligned with a corresponding connection pin 422 of the second set of connection pins 418.

An alternate configuration of cartridge 12 is designed by the reference numeral 12a. It is contemplated for cartridge 12a to include one or more of channel networks 26, 26a, 26b and 26c, heretofore described. Cartridge 12a is defined by a generally flat, upper surface 424 interconnected to a generally flat, lower surface 426 by first and second ends 428 and 430, respectively, and first and second end members 406 and 408, respectively. First and second sides 432 and 434, respectively, of cartridge 12 have lengths generally equal to the lengths of first and second sides 412 and 414, respectively, of frame 400 along inner edge 410 thereof. First and second C-shaped connectors 436 and 438, respectively, project from corresponding first and second ends 428 and 430, respectively, of cartridge 12a. First C-shaped connector 436 is adapted to form mating relationships with a corresponding connection pin 420 of the first set of connection pins 416 projects from first side 412 of frame 400 and second C-shaped connector 438 is adapted to form mating relationships with a corresponding connection pin 422 of the second set of connection pins 418 projecting from second side 412 of frame 400, so as to allow cartridge 12a to be selectively connected and disconnected to frame 400, FIG. 41. In such manner, cartridges 12a having different channel networks 26, 26a, 26b and 26c therein may be connected and disconnected to frame 400, thereby allowing a user to customize microfluidic device 10 as needed.

Various modes of carrying out the invention are contemplated as being within the scope of the following claims particularly pointing out and distinctly claiming the subject matter, which is regarded as the invention.

We claim:

1. A microfluidic device for profiling biochemical samples, comprising:
a cartridge defining a channel network, the channel network including:
a channel having first and second opposite ends;
a first well adjacent the first end of the channel, the first well adapted for receiving a first fluid therein;
a first loading port extending between the first well and the channel, the first loading port having a sufficient dimension to allow the first fluid to flow into the channel;
a second well disposed between the first and second ends of the channel, the second well adapted for receiving a second fluid therein;
a second loading port extending between the second well and the channel, the second loading port having a dimension to pin the second fluid in the second well; and
an air outlet adjacent to the second end of the channel, the air outlet allowing an interior of the channel to communicate with an environment external of the cartridge;
wherein:
capillary action causes the first fluid received in the first well to flow into the channel through the first loading port and toward the air outlet; and
at least a portion of the first fluid flowing through the channel flows into the second well through the second loading port.

2. The microfluidic device of claim 1 wherein the channel is a first channel, the air outlet is a first air outlet, and the channel network includes:
a second channel having first and second opposite ends;
a third well adjacent the first end of the second channel, the third well adapted for receiving a third fluid therein;
a third port extending between the third well and the second channel, the third loading port having a sufficient dimension to allow the third fluid to flow into the second channel;
a fourth loading port extending between the second well and the second channel; and
a second air outlet adjacent to the second end of the second channel, the second air outlet allowing an interior of the second channel to communicate with an environment external of the cartridge;
wherein:
capillary action causes the third fluid received in the third well to flow into the second channel through the third loading port and toward the second air outlet; and
at least a portion of the third fluid flowing through the second channel flows into the second well through the fourth loading port.

3. The microfluidic device of claim 1 wherein the channel network is a first channel network and wherein the cartridge further includes a second channel network, the second channel network defined by:
a channel having first and second opposite ends;
a first well adjacent the first end of the channel of the second channel network, the first well of the second channel network adapted for receiving a third fluid therein;
a first loading port extending between the first well of the second channel network and the channel of the second channel network, the first loading port of the second channel network having a sufficient dimension to allow the third fluid to flow into the channel of the second channel network;
a second well disposed between the first and second ends of the channel of the second channel network, the second well of the second channel network adapted for receiving a fourth fluid therein; and
a second loading port extending between the second well of the second channel network and the channel of the second channel network, the second loading port of the second channel network having a dimension to pin the fourth fluid in the second well of the second channel network.

4. The microfluidic device of claim 3 wherein the second channel network is further defined by:
an air outlet adjacent to the second end of the second channel network, the air outlet of the second channel network allowing an interior of the channel of the second channel network to communicate with an environment external of the cartridge;
wherein:
capillary action causes the third fluid received in the first well of the second channel network to flow into the channel of the second channel network through the first loading port of the second channel network and toward the air outlet of the second channel network; and
at least a portion of the third fluid flowing through the channel of the second channel network flows into the second well of the second channel network through the second loading port of the second channel network.

5. The microfluidic device of claim 3 wherein the channel of the second channel network communicates with the air outlet adjacent to the second end of the channel of the second channel network, the air outlet allowing an interior of the channel of the second channel network to communicate with an environment external of the cartridge;
wherein:
capillary action causes the third fluid received in the first well of the second channel network to flow into the channel of the second channel network through the first loading port of the second channel network and toward the air outlet; and
at least a portion of the third fluid flowing through the channel of the second channel network flows into the second well of the second channel network through the second loading port of the second channel network.

6. The microfluidic device of claim 1 wherein the channel is first channel, the channel network further includes:
a second channel having first and second opposite ends;
a third well disposed between the first and second ends of the second channel, the third well adapted for receiving a third fluid therein; and
a third loading port extending between the third well and the second channel, the third loading port having a dimension to pin the third fluid in the third well; and
wherein:
the first loading port communicates with the second channel adjacent the first end of the second channel.

7. The microfluidic device of claim 6 wherein the air outlet communicates with the second end of the second channel.

8. The microfluidic device of claim 6 wherein the air outlet is a first air outlet and wherein:
the channel network further includes a second air outlet adjacent to the second end of the second channel, the second air outlet allowing an interior of the second channel to communicate with an environment external of the cartridge; and
capillary action causes the first fluid received in the second channel to flow into the second channel through the first loading port and toward the second air outlet.

9. The microfluidic device of claim 6 wherein a length of the first channel between the first loading port and the second loading port is generally equal to a length of the second channel between the first loading port and the third loading port.

10. The microfluidic device of claim 1 further comprising a frame having first and second sides and first and second ends and wherein the cartridge includes:
first and second ends;
a first connector connected to the cartridge adjacent the first end of the cartridge, the first connector removably connectable to the first side of the frame; and
a second connector connected to the cartridge adjacent the second end of the cartridge, the second connector removably connectable to the second side of the frame.

11. A microfluidic device for profiling biochemical samples, comprising:
a cartridge defining a channel network, the channel network including:
a channel having first and second opposite ends;
a first well communicating with the first end of the channel, the first well adapted for receiving a first fluid therein;
a second well in communication with the channel through a loading port at a location between the first and second ends of the channel, the second well adapted for receiving a second fluid therein; and
an air outlet in communication with the channel at a location adjacent to the second end of the channel, the air outlet allowing an interior of the channel to communicate with an environment external of the cartridge;
wherein:
capillary action causes the first fluid received in the first well to flow into the channel toward the air outlet;
the second loading port having a dimension to pin the second fluid in the second well; and
at least a portion of the first fluid flowing through the channel flows into the second well.

12. The microfluidic device of claim 11 wherein the channel is a first channel, the loading port is a first loading port, and the air outlet is a first air outlet, and the channel network includes:
a second channel having first and second opposite ends;
a third well communicating the first end of the second channel, the third well adapted for receiving a third fluid therein;
a second loading port extending between the second well and the second channel; and
a second air outlet adjacent to the second end of the second channel, the second air outlet allowing an interior of the second channel to communicate with an environment external of the cartridge;
wherein:
capillary action causes the third fluid received in the third well to flow into the second channel toward the air outlet; and
at least a portion of the third fluid flowing through the second channel flows into the second well through the second loading port.

13. The microfluidic device of claim 11 wherein the channel network is a first channel network and wherein the cartridge further includes a second channel network, the second channel network defined by:
a channel having first and second opposite ends;
a first well communicating with the channel of the second channel network at a location adjacent the first end of the channel of the second channel network, the first well of the second channel network adapted for receiving a third fluid therein; and
a second well communicating with the channel of the second channel network through a loading port at a location between the first and second ends of the channel of the second channel network, the second well of the second channel network adapted for receiving a fourth fluid therein;
wherein the loading port of the second channel network has a dimension to pin the fourth fluid in the second well of the second channel network.

14. The microfluidic device of claim 13 wherein the second channel network further includes:
an air outlet in communication with the channel of the second channel network at a location adjacent to the second end of the second channel network, the air outlet of the second channel network allowing an interior of the channel of the second channel network to communicate with an environment external of the cartridge;
wherein:
capillary action causes the third fluid received in the first well of the second channel network to flow into the channel of the second channel network toward the air outlet of the second channel network; and
at least a portion of the third fluid flowing through the channel of the second channel network flows into the second well of the second channel network through the loading port of the second channel network.

15. The microfluidic device of claim 13 wherein the channel of the second channel network communicates with the air outlet at a location adjacent to the second end of the channel of the second channel network, the air outlet allowing an interior of the channel of the second channel network to communicate with an environment external of the cartridge;
wherein:
capillary action causes the third fluid received in the first well of the second channel network to flow into the channel of the second channel network toward the air outlet; and
at least a portion of the third fluid flowing through the channel of the second channel network flows into the second well of the second channel network through the loading port of the second channel network.

16. The microfluidic device of claim 11 wherein the channel is first channel and the loading port is a first loading port, the channel network further includes:
a second channel having first and second opposite ends;
a third well in communication with the second channel through a second loading port at a location between the first and second ends of the second channel, the third well adapted for receiving a third fluid therein; and
wherein:
the first well in communication with the second channel at a location adjacent the first end of the second channel.

17. The microfluidic device of claim 16 wherein the air outlet is in communication with the second end of the second channel.

18. The microfluidic device of claim 16 wherein the air outlet is a first air outlet and wherein:
the channel network further includes a second air outlet in communication with the second channel at a location adjacent to the second end of the second channel, the second air outlet allowing an interior of the second channel to communicate with an environment external of the cartridge; and
capillary action causes the first fluid received in the second channel to flow into the second channel toward the second air outlet.

19. A microfluidic device for profiling biochemical samples, comprising:
a cartridge defining a channel network, the channel network including:
a channel having first and second opposite ends;
a first loading port in communication with the channel, the first loading port configured to allow introduction of a first fluid into the channel;
a well in communication with the channel through a second loading port and located between the first loading port and the second end of the channel, the second well adapted for receiving a second fluid therein; and
an air outlet in communication with channel at a location adjacent to the second end of the channel, the air outlet allowing an interior of the channel to communicate with an environment external of the cartridge;
wherein:
the second loading port has a dimension to pin the second fluid in the second well;
the first fluid received in the first well flows into the channel toward the air outlet; and
at least a portion of the first fluid flowing through the channel flows into the second well through the second loading port.

20. The microfluidic device of claim 19 wherein the channel network is a first channel network and wherein the cartridge further includes a second channel network, the second channel network defined by:
a channel having first and second opposite ends;
a first loading port in communication with the channel of the second channel network, the first loading port of the second channel network configured to allow introduction of a third fluid into the channel of the second channel network; and
a well in communication with the channel of the second channel network through a second loading port and located between the first loading port of the second channel network and the second end of the channel of the second channel network, the well of the second channel network adapted for receiving a fourth fluid therein;
wherein the second loading port of the second channel network has a dimension to pin the fourth fluid in the second well of the second channel network.

21. The microfluidic device of claim 20 wherein the second channel network further includes an air outlet in communication with the channel of the second channel network at a location adjacent to the second end of the second channel network, the air outlet of the second channel network allowing an interior of the channel of the second channel network to communicate with an environment external of the cartridge.

22. The microfluidic device of claim 20 wherein the channel of the second channel network communicates with the air outlet at a location adjacent to the second end of the channel of the second channel network, the air outlet allowing an interior of the channel of the second channel network to communicate with an environment external of the cartridge.

23. The microfluidic device of claim 19 wherein the channel is first channel, the channel network further includes:
a second channel having first and second opposite ends, the second channel in communication with the first loading port;
a second well in communication with the second channel through a third loading port at a location between the first loading port and the second end of the second channel, the second well adapted for receiving a third fluid therein.

24. The microfluidic device of claim 23 wherein the air outlet is in communication with the communication with the second channel at a location adjacent the second end of the second channel.

25. The microfluidic device of claim 23 wherein the air outlet is a first air outlet and wherein:
the channel network further includes a second air outlet in communication with the second channel at a location adjacent to the second end of the second channel, the second air outlet allowing an interior of the second channel to communicate with an environment external of the cartridge.
